(19) United States
(12) Patent Application Publication
(10) Pub. No.: US 2021/0278833 A1
(43) Pub. Date: Sep. 9, 2021

(54) SUPPORT SYSTEM FOR AUTOMATED BUILDING MANAGEMENT ASSISTANCE

(71) Applicant: Siemens Industry, Inc., Alpharetta, GA (US)

(72) Inventors: Robert Hafernik, Austin, TX (US); Rebekka Bryant, Houston, TX (US); Tyrell Craig Vaughn, Manchaca, TX (US)

(21) Appl. No.: 16/813,339

(22) Filed: Mar. 9, 2020

(51) Int. Cl. G05B 23/02; G06Q 10/00

(52) U.S. Cl. CPC G05B 23/0294; G06Q 10/20; G05B 23/0272; G05B 23/0216

(57) ABSTRACT

There is described a support system and method for automated building management assistance. Fault detection and diagnostics relating to a maintenance event for building equipment is collected from a building automation system in response to receiving a message identifying the maintenance event from a mobile device. Manual tasks are provided to the mobile device to address the maintenance event in response to identifying the status as a basic issue. The manual tasks include manual actions to be executed at the equipment at the particular building based on interactions between the automated support system and the mobile device. Semi-automated tasks are provided to the mobile device to address the maintenance event in response to identifying the status as an advanced issue. The semi-automated tasks include one or more manual tasks and one or more automated tasks determined by the automated support system for execution by the building automation system.

### FIELD OF THE INVENTION

This application relates to the field of building management and, more particularly, to support systems for automated building management assistance.

### BACKGROUND

Building automation systems encompass a wide variety of systems that aid in the monitoring and control of various aspects of building operation for a facility. A building automation system may also control equipment for multiple facilities or subsystems, such as security systems, fire safety systems, lighting systems, and heating, ventilation, and air conditioning (HVAC) systems. Lighting systems and HVAC systems are sometimes referred to as “environmental control systems” to control the environmental conditions within a building or facility.

The elements of a building automation system may be widely dispersed throughout a facility. For example, an HVAC system may include temperature sensors and ventilation damper controls as well as other elements that are located in virtually every area of a facility or campus. Similarly, a security system may have intrusion detection, motion sensors and alarm actuators dispersed throughout an entire building or campus. Likewise, fire safety systems include smoke alarms and pull stations dispersed throughout the facility or campus. The different areas of a building automation system may have different environmental settings based upon the use and personal likes of people in those areas, such as offices and conference rooms.

A service organization may send a technician to a building when equipment at the building experiences an issue or needs maintenance. The technician is present at the buildings to maintain or repair the equipment needing attention. For advanced issues, the on-site technician may solicit the assistance of a human staff member at a remote support facility to consult with the technician via a mobile phone. The support staff provides guidance and technical information about the building to assist the on-site technician. Even so, resolution of maintenance or advanced issues may be time-consuming and expensive, particularly when the issues are complex and extensive or when multiple issues need to be addressed.

SUMMARY

In accordance with one embodiment of the disclosure, there is provided an automated support approach for building automation systems. A facility with a building automation system installed may provide access to an enormous amount of data. Thus, a support system for automated building management assistance may have access to the full state of the facility at any time, which amounts to a large volume of data points. The support system may also be provided access to the historical or trend data for the data points, the alarm and fault detection and diagnostics (FDD) status of various systems and subsystems, the maintenance history of the facility via to the building automation system or other related systems, and access to third party or external data, such as weather or traffic data. The support system may further command the building automation system to actuate controls (such as VAV dampers), change HVAC set points, change schedules, override control strategies, actuate lighting contactors, and other functions of the building automation system and its associated building equipment.

One aspect is a system for automated building management assistance comprising a mobile device, a building automation system, and a support system. The mobile device is configured to provide a first message identifying a maintenance event for equipment at a particular building and receive a second message identifying completion of the maintenance event for the equipment at the particular building. The building automation system is configured to provide fault detection and diagnostics relating to the maintenance event in response to receiving the first message. The support system is configured to identify a status of the maintenance event as a basic issue or an advanced issue based on the fault detection and diagnostics. The support system also provides manual tasks to the mobile device to address the maintenance event in response to identifying the status as the basic issue and provides semi-automated tasks to the mobile device to address the maintenance event in response to identifying the status as the advanced issue. The manual tasks include manual actions to be executed at the equipment at the particular building based on interactions between the automated support system and the mobile device. The semi-automated tasks include one or more manual actions and one or more automated actions determined by the automated support system for execution by the building automation system.

Another aspect is a support system for automated building management assistance comprising a first communication component, a second communication component, and a processor. The first communication component is configured to communicate with a mobile device. The first communication component receives a first message identifying a maintenance event for equipment at a particular building and transmits a second message identifying completion of the maintenance event for the equipment at the particular building. The second communication component configured to communicate with a building automation system. The second communication component collects fault detection and diagnostics relating to the maintenance event in response to receiving the first message. The processor is configured to identify a status of the maintenance event as a basic issue or an advanced issue based on the fault detection and diagnostics. The processor also provides manual tasks to the mobile device to address the maintenance event in response to identifying the status as the basic issue and provide semi-automated tasks to the mobile device to address the maintenance event in response to identifying the status as the advanced issue. The manual tasks include manual actions to be executed at the equipment at the particular building based on interactions between the automated support system and the mobile device. The semi-automated tasks include one or more manual actions and one or more automated actions determined by the automated support system for execution by the building automation system.

Yet another aspect is a method of a support system for automated building management assistance. A first message is received, from a mobile device, identifying a maintenance event for equipment at a particular building. Fault detection and diagnostics relating to the maintenance event is collected from a building automation system in response to receiving the first message. A status of the maintenance event is identified based on the fault detection and diagnostics, in which the status being one of a basic issue or an advanced issue. Manual tasks are provided to the mobile device to address the maintenance event in response to identifying the status as the basic issue. The manual tasks include manual actions to be executed at the equipment at the particular building based on interactions between the automated support system and the mobile device. Semi-automated tasks are provided to the mobile device to address the maintenance event in response to identifying the status as the advanced issue. The semi-automated tasks include one or more manual actions and one or more automated actions determined by the automated support system for execution by the building automation system. A second message is transmitted, to the mobile device, identifying completion of the maintenance event for the equipment at the particular building.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 is a block diagram of an example environment that is operable to employ techniques described herein.

FIG. 2 is a flow diagram of an example operation of the environment represented in FIG. 1.

FIG. 3 is a block diagram of an example implementation of a building automation system operable to employ techniques described herein.

FIG. 4 is a block diagram of an example implementation of an automated support system of the building automation system represented in FIG. 3.

FIG. 5 is a flow diagram of an example operation of the automated support system of FIG. 4.

FIG. 6 is a block diagram of an example implementation of a mobile device represented in FIG. 1.

FIG. 7 is a flow diagram of an example operation of the mobile device of FIG. 6.

### DETAILED DESCRIPTION

Various technologies that pertain to systems and methods that facilitate support system for automated building management assistance will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

The support system for automated building management assistance cooperates with a building automation system to assist human maintenance technician. Expert systems may guide a maintenance technician through maintenance tasks by following decision trees. More importantly, the support system automatically provides guidance about common maintenance tasks and makes automated decisions for addressing technical issues based on real-time access to the state of the building including alarms, historical data about the state of the building including fault detection and diagnostics (FDD) and analytical results and maintenance history, and external data such as weather and traffic information. In addition, the support system may have the capability of commanding the building automation system of the facility to change its state as needed. Examples of such commands include, but are not limited to, changing the state of dampers, valves and lighting contactors; changing the building configuration, such as set points or schedules; and commanding various systems, such as HVACs, to alter their behavior.

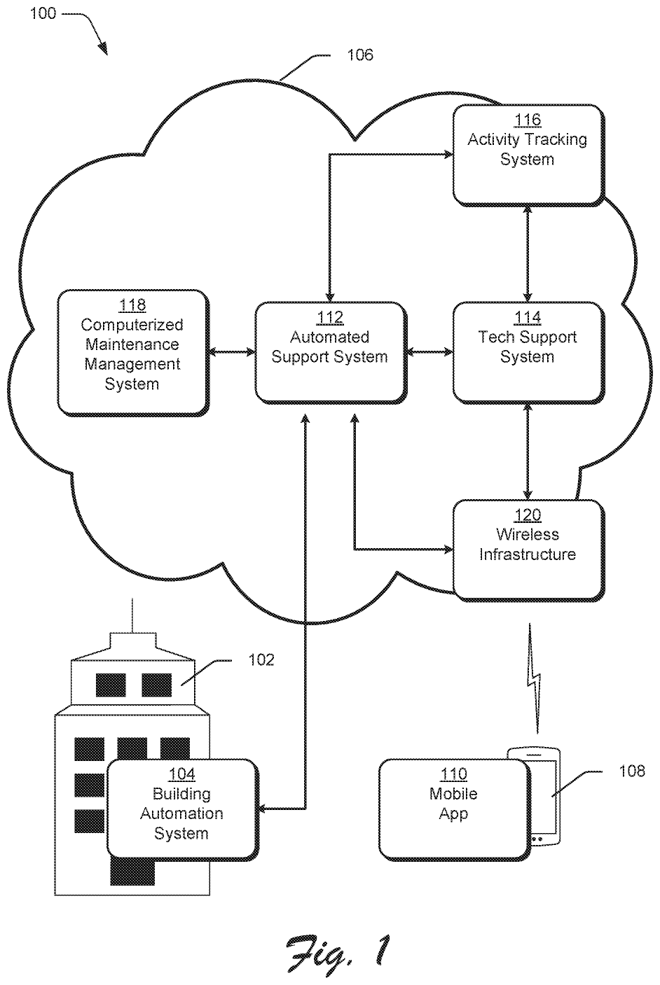

Referring to the FIG. 1, there is shown an example environment 100 that is operable to employ techniques described herein. The environment 100 comprises a facility 102 managed by a building automation system (BAS) 104, which may be co-located in part or entirely with the facility. The BAS 104 is configured to provide fault detection and diagnostics relating to maintenance events to remote devices and control the building systems, such as HVAC and lighting, and collects data relating to the performance of the facility 102. Maintenance events include, but are not limited to, maintenance or advanced issues that need to be addressed for proper or optimal operation of the facility 102 and the BAS 104. The environment 100 also comprises an external network or cloud 106, external to the facility 102 and the BAS 104, communicating with the BAS 104 and one or more mobile devices 108. The external network 106 communicating with the BAS 104 collects and stores data relating to the operation of the facility 102 and the BAS 104, identifies trends from the data, and performs analytics on the data, such as FDD. For some embodiments, each mobile device 108 may include a mobile app 110 that may communicate with the external network 106 via a communication component of the mobile device 108.

The external network 106 comprises an automated support system 112 and a technical support system 114. The automated support system 112 provides automated building management assistance for a maintenance event, and the technical support system 114 is configured to provide manual tasks and/or semi-automated tasks to address the maintenance event. The technical support system 114 may be coupled to, or include, an activity tracking system 116 that queues and tracks tasks and calls assigned to the technical support system 114. The information in the activity tracking system 116 may also be accessed by the automated support system 112 in full or on a limited basis.

The external network 106 may also comprise a computerized maintenance management system (CMMS) 118 and/or wireless infrastructure 120. The CMMS 118 communicates with the automated support system 112 and manages the scheduling and tracking of maintenance events by assigning a ticket to each event and tracking the status of each event over time. The wireless infrastructure 120 provides wireless communication capabilities to the external network 106, if not otherwise available via another device of the external network, for communication with one or more mobile devices 108. The wireless infrastructure 120 may provide a communication link between the automated support system 112 and a mobile device 108 and/or the technical support system 114 and the mobile device.

The interaction and operation of the devices of the environment 110 may be explained by the following example. A technician may receive, or otherwise be aware of, a ticket associated with a maintenance event for repair or maintenance of a building issue of the facility 102. When the technician arrives at the location associated with the maintenance event, the technician begins communications with the automated support system 112 by logging-in to the system via a mobile device 108, such as a laptop, tablet, phone, or other type of wireless communication device. The technician may receive assistance from the automated support system 112 via a mobile device 108, such as a laptop, tablet, phone, or other type of wireless communication device. The automated support system 112 may query the CMMS 118 for open tickets. Where there is more than one possible open ticket associated with the facility 102 or area of the facility, the automated support system 112 may then query the mobile device 108 to determine the appropriate ticket among the multiple possible open tickets.

During the above operation, the technician may be supported by live human technical support staff, via telephone, such as links between the technical support system 114 and the mobile device 108 through wireless infrastructure 120. The technical support staff also has access to the automated support system 112 via a link within the external network 106 while assisting the on-site technician. For example, when the technician arrives on-site at the facility 102, the technician may use the mobile app 110 of the mobile device 108 to request access to control the automated support system 112 via the mobile app 110. Once that access is granted, the technician may also optionally use the mobile app 110 to request a call from the technical support staff of the technical support system 114. Whether the technician asks for live assistance from a technical support staff or not, the technician may use the mobile app 110 to assist with her or his repair tasks.

The mobile device 108 may know from the location of the technician which facility 102, or area of the facility, is associated with the maintenance event. For some embodiments, a location determining component of the mobile device 108, such as a sensor for a Global Positioning System (GPS), may determine the location coordinates of the mobile device. The mobile device 108 may also have access to the records of the automated support system 112, or the BAS 104 via the automated support system, the reason dispatching the technician to the site. The automated support system 112 may then proceed to assist the technician with her or his task, using a variety of techniques such as control algorithms and/or machine learning techniques, without requiring the involvement of the technical support staff.

For example, the automated support system 112 may note that the technician has been dispatched to repair a particular HVAC or lighting system. The mobile device 108 may then proceed to prompt the technician through standard steps to begin repair, such as checking that the system has power, the system is in communication with the automated support system 112, and so on. As needed, the automated support system 112 may also perform other automated tasks to assist the technician. If the system under repair is an HVAC system, the automated support system 112, for example, may run an automated hot/cold test on the HVAC unit and present the results to the technician.

As the automated support system 112 is assisting the technician, the system may record some or all interactions and data gathered as part of the dispatch to the facility 102. Once technical support staff associated with the technical support system 114 becomes available to assist the on-site technician, the data is available to set the context for the voice or text conversation. After the repair or maintenance task is completed, some or all records are stored at the automated support system 112 to be made available the next time a technician is on-site at the facility 102.

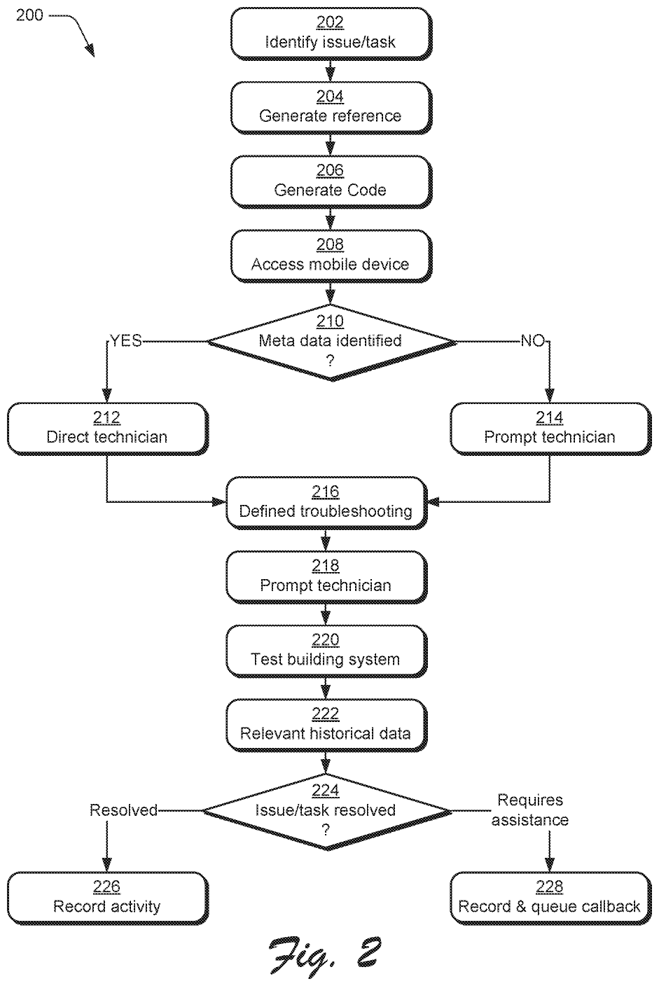

Referring to FIG. 2, there is shown an example operation of the environment 100. A maintenance event, such as an equipment issue or maintenance task, may be identified 202. The maintenance event may be identified by a person or automated fault detection device at the BAS 104, the automated support system 112 or the CMMS 118. A reference identifier, used for tracking the maintenance event, may be generated 204 in response to identifying the maintenance event. The reference identifier may be generated by a person or automated system at the BAS 104, the automated support system 112 or the CMMS 118. An authentication code may be generated and provided to an on-site technician for interrogation of the maintenance event 206 in response to identifying the maintenance event 202 or generating the reference identifier 204. The authentication code may include a reference to a location and/or an equipment associated with the maintenance event. The authentication code may also include a description relating to the nature of the required on-site visit. For example, the CMMS 118 may receive the authentication code from the automated support system 112 and adds the authentication code to the ticket corresponding to the maintenance event. The CMMS system 118 then schedules a technician to visit the site, supplying some or all of the information identified by the ticket.

A technician may arrive at the facility associated with the maintenance event as a result of the scheduled visit identified by the ticket of the CMMS system 118. Upon arrival, the technician may use the authentication code provided by the ticket to operate the mobile device 108, 208, such as accessing or logging-in to the mobile app 110. For some embodiments, the mobile device 108 may use a location determining component, such as a sensor for a Global Positioning System (GPS), to confirm that the technician is at the site.

The mobile device 108 may determine whether there is any meta data 210 available to the mobile device in response to receiving the authentication code. For some embodiments, the mobile device 108 may retrieve meta data from a memory component of the mobile device that relates to the equipment referenced by the authentication code. For some embodiments, the mobile device 108 may retrieve information from a relevant open ticket at the CMMS 118, directly or via the automated support system 112, and provide information about the maintenance event to the mobile device. If meta data is available, then the mobile device 108 may display or otherwise provide information about the maintenance event to an output component of the mobile device 212. For example, the mobile device 108 may display information about the location of the equipment associated with the maintenance event and/or unique identification associated with the equipment. If the meta data is not available, then the mobile device 108 may prompt the technician for a location or other information about the equipment at an input component of the mobile device 214. Examples of prompted information include, but are not limited to, model number, serial number, manufacturer identification, and label names. The mobile device 108 may further store prompted information at the memory component of the mobile device or at a remote database such as one at the automated support system 112 or the CMMS 118. The mobile device 108 may further query about other information, such as a confirmation that the current visit to the site corresponds to the maintenance event. In such case, when the technician confirms, the automated support system 112 may retrieve the other information, such as a document created when the site was commissioned, showing the layout of the equipment, the building layout information, associated wiring, associated panels, and the like, and utilize the mobile device 108 to present (such as display) the other information to the technician. Examples of the building layout information include, but are not limited to, structure, equipment, venting, plumbing, and/or wiring layout associated with the particular building.

The automated support system 112 may also collect data about the equipment associated with the maintenance event via the BAS 104, such as fault detection and diagnostics data. Examples of the fault detection and diagnostics data include, but are not limited to, a current operating state of at least one unit of the building maintenance system, a current communication states between at least two units of the building maintenance system (for example, whether all units are in communication with the BAS 104), a previous maintenance event of the equipment (for example, when the equipment was last maintained), or a recent maintenance event of the building maintenance system (for example, whether there other support tickets at the CMMS 118 currently outstanding for other equipment and what other faults have been revealed recently).

The automated support system 112 may consolidate the meta data and any other collected data and determine the approach for troubleshooting the maintenance event 216, 218. After confirming that the technician is ready to begin diagnosing the problem referenced by the authentication code, the automated support system 112 may direct the technician, via the mobile device 108, to perform defined troubleshooting steps 216. For some embodiments, the troubleshooting steps directed by the automated support system 112 may be based on a decision tree corresponding to a type of task associated with the maintenance event. For some embodiments, the automated support system 112 may consolidate the data into a concise report for display by the mobile device 108. Some equipment of the facility 102 may experience basic issues, such as units that perform nominally and require only routine preventative maintenance and units that may perform poorly due to clearly identifiable problems. Other equipment of the facility 102 may experience nominal issues that do not require immediate attention. For example, some equipment may operate comparatively since their last maintenance and may be ignored for the current visit. Still other equipment may experience advanced issues that require further investigation. An example of an advanced issue a unit of an HVAC system that creates cool air but is not able to reduce the temperature within a particular area to a desired set point of the unit.

For some embodiments, the automated support system 112 may distill the consolidated data into a tree of tasks. For example, for well-performing units, tasks may be sequentially linear and based on a standard HVAC technician handbook, such as changing a filter, cleaning a coil, checking a fan belt, and the like. The mobile device 108, operated by the technician, may acknowledge each task as it is performed or completed, and the acknowledgment may be logged by the automated support system 112 and/or the mobile device 108. For this example, for units that are not performing well, tasks may be tailored based on the problem. For example, if a unit seems ineffective, the automated support system 112 may provide instructions at the mobile device 108 to check the fan, check the coils for possible problems (e.g., an iced condition), check the diffuser for possible blockage, and the like.

During the course of defined troubleshooting 216, the automated support system 112 may prompt the technician, via the mobile device 108, to perform troubleshooting steps and respond with results observed or received by the technician 218. The troubleshooting steps may include manual actions directly applied to equipment such as controlling a panel or disassembling equipment, and the troubleshooting steps may also include manual actions indirectly applied to equipment such as prompting the technician to capture an image, sound, or multimedia of one or more components of the equipment. Also, during the course of defined troubleshooting 216, the automated support system 112 may command the BAS 104 to run diagnostics and/or test results of attempted troubleshooting steps 220. For example, may command the BAS 104 to order the HVAC to execute a cooling or heating operation and gather information about the supply, zone, duct and outside air temperature. The automated support system 112 may initiate the command automatically in response to a condition or status of the defined troubleshooting 216 or in response to an input by a technician at the mobile device 108. The gathered information may then be presented to the technician and drive the next item in the tree of possibilities. For some embodiments, the automated support system 112 may provide data to the technician, such as displaying information at the mobile device 108, corresponding to the performance of the equipment associated with the maintenance event, in response to and as a result of commanding the BAS 104. The automated support system 112 may further provide historical data associated with the maintenance event, or one or more steps, during the defined troubleshooting 222.

While directing the technician through tasks, the automated support system 112 may further log each task, gathering associated data from the building and the technician's responses. Also, the automated support system 112 may detect situations indicative of insufficient checking by a technician, i.e., “pencil-whipping” through one or more tasks, based on insufficient time spent on a particular task or group of tasks. In addition, the automated support system 112 may create a record of on-going activities in the activity tracking system 116 of, or associated with, the technical support system 114. As the automated support system 112 records the technician's progress, the automated support system may identify a particular task requiring non-automated assistance. In response to identifying the particular task, the automated support system 112 instructs the technical support system 114 to connect with the mobile device 108 or add the mobile device to its queue. For example, the automated support system 112 may receive the phone number of the mobile device 108 from the mobile device and forward the phone number to the technical support system 114 for a callback. Also, the technical support system 114 may familiarize itself with and/or display information to associated support staff relating to the situation of the technician, including all the work performed, before contacting the technician via the mobile device 108.

The automated support system 112 may determine whether the equipment issues or maintenance tasks of the maintenance event are resolved or require additional assistance 224 in response to completion of troubleshooting steps and associated actions 216-222. If the issues and tasks are resolved, then a record of the technician's visit is stored at the automated support system 112, the activity tracking system 116, and/or the CMMS 118 (226). The record may include steps performed during the visit as well as the results of the steps. The record may be referenced by the technician, or future technicians, along with any images, sounds, and/or multimedia captured during the visit. For example, after the mobile device 108 communicates to the automated support system 112 that tasks of the maintenance event have been completed, the automated support system make record information associated with the visit, including the resulting performance of the BAS 104. The automated support system 112 may then create automatically an activity in the activity tracking system 116 for the technical support system 114 to review the record and assess the technician's performance. The automated support system 112 may also update the ticket at the CMMS 118 and mark it as complete. If the issues and tasks are not yet resolved, then a record of the technician's progress as provided by the mobile device 108 may be stored at the automated support system 112, the activity tracking system 116, and/or the CMMS 118 (228). In addition, the automated support system 112 may determine that the technician requires assistance, if not previously already determined, and place the technician in a queue for a callback by the technical support system 114 (228).

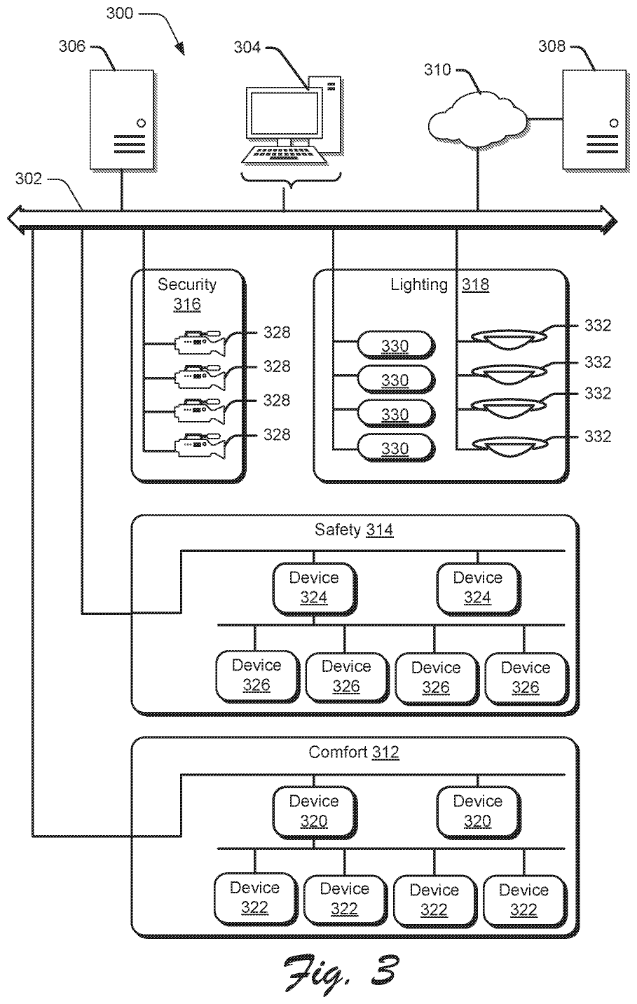

Referring to FIG. 3, there is shown a BAS 300, in an example implementation of the BAS 104 of FIG. 1, that is operable to employ techniques described herein. The BAS 300 includes an environmental control system configured to control one or more environmental parameters for a facility, such as temperature, humidity, ventilation, lighting, fire safety, security, and the like. For example, the BAS 300 may comprise one or more network connections or buses 302 for connectivity to components of the system. For example, the example BAS 300 may comprise one or more management devices, such as a management workstation 304 and a management server 306, for setting and/or changing of various controls of the system. The BAS 300 is coupled to, and assisted by, an automated support system 308 (which is an example implementation of the automated support system 112 of FIG. 1) connecting through a wired or wireless network 310. The automated support system 308 provides automated building management assistance for maintenance events. While a brief description of the BAS 300 is provided below, it will be understood that the BAS 300 described herein is only one example of a particular form or configuration for a BAS. The system 300 may be implemented in any other suitable manner without departing from the scope of this disclosure.

The management devices 304, 306 are configured to provide overall control and monitoring of the BAS 300. For the illustrated embodiment of FIG. 3, the BAS 300 provides connectivity to subsystems for various environmental parameters such as components of comfort systems 312, safety systems 314, security systems 316, and lighting systems 318. For example, comfort systems 312 may include various devices 320, 322 for monitoring and controlling heating, cooling, and ventilation of areas within a building or group of buildings. Examples of comfort devices include, but are not limited to, stations, field panels, field controllers, field devices, and the like. Some devices 320 may communicate directly with a network connection or bus 302, whereas other devices 322 may communicate through, and perhaps be controlled by, another device. Similarly, safety systems 314 may include various devices 324, 326 for monitoring and controlling fire protection for areas within a building or a group of buildings. Examples of safety devices include, but are not limited to controllers, control panels, detectors, alarm systems, video surveillance cameras, and the like. Similar to comfort devices, some safety devices 324 may communicate directly with a network connection or bus 302, whereas other safety devices 326 may communicate through, and perhaps be controlled by, another device. As stated above, the illustrated embodiment of the BAS 300 may provide connectivity to subsystems 328 for security systems 316 and other systems, such as video surveillance cameras and motion detectors, for monitoring and controlling various areas within a building or a group of buildings.

The lighting systems 318 may include various devices 330, 332 for monitoring and controlling illumination of areas within a building or group of buildings.

Examples of lighting devices include, but are not limited to, lighting sensors such as occupancy sensors, lighting controllers such as UV light controllers, lighting switches, lighting gateways, lighting hubs, lighting servers, and the like. Occupancy sensors include, but are not limited to, light sensors, motion sensors, temperatures sensors, image sensors (such as still and video images), and air quality sensors. Lighting controllers may be connected to, or integrated with, light fixtures of a particular area. Similar to the comfort, safety, and security devices, lighting devices may communicate directly with a network connection or bus 302, and/or through, and perhaps be controlled by, another device. The lighting system 318 may include legacy or 3rd party devices to be coupled to other devices of the BAS 300. It is to be understood that the system 300 may comprise any suitable number of any of components based on the particular configuration for each building or group of buildings.

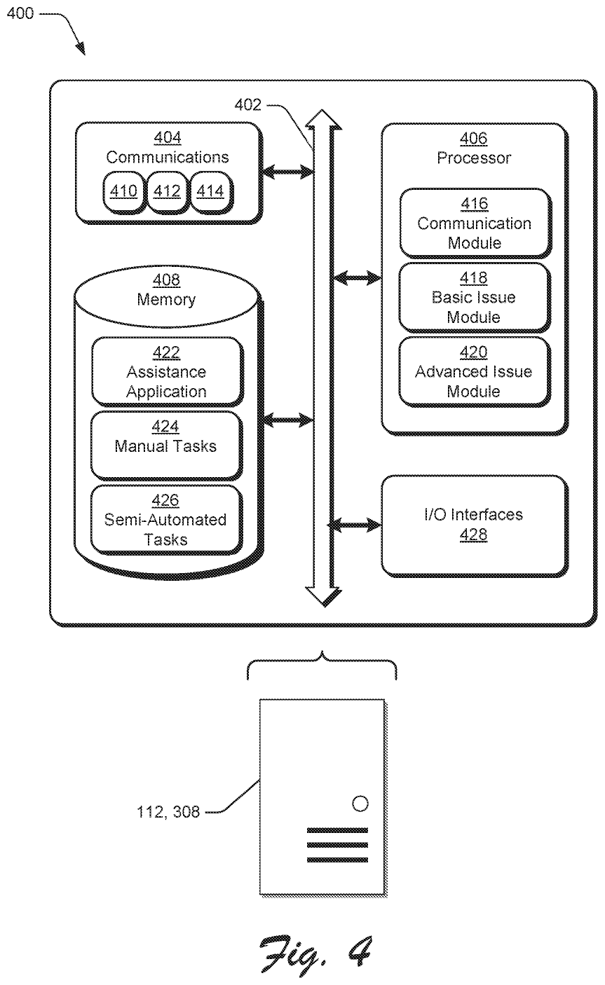

FIG. 4 represents example device components 400 of an automated support system that may operate in the environment 100, employing the techniques described herein, such as the system 112 of FIG. 1 and the system 308 of FIG. 3. The device components 400 comprise a communication bus 402 for interconnecting components directly or indirectly. The device components further comprise one or more communication components 404 communicating other entities of the environment 100 via a wired or wireless link, one or more processors 406, and one or more memory components 408. The communication component 404 may utilize wired technology for communication, such as transmission of data over a physical conduit, e.g., an electrical wire, electrical cable, or optical fiber. The communication component 404 of the device components 400 may also, or in the alternative, utilize wireless technology for communication, such as, but are not limited to, Bluetooth (including BLE), Wi-Fi (including Wi-Fi Direct), Zigbee, Z-Wave, 6LoWPAN, Near-Field Communication, other types of electromagnetic radiation of a radio frequency wave, light-based communications (including infrared), acoustic communications, and any other type of peer-to-peer technology. The communication component 404 includes one or more communication interfaces or links to devices of the environment 100, such as a BAS interface 410, a CMMS interface 412, and/or a technical support interface 414. The communication component 404 further includes an interface to the wireless infrastructure 120 and/or a wireless interface to the mobile device 108.

The processor 406 may execute code and process data received other components of the device components 400, such as information received at the communication component 404 or stored at the memory component 408. The code associated with the automated support system and stored by the memory component 408 may include, but is not limited to, operating systems, applications, modules, drivers, and the like. An operating system includes executable code that controls basic functions of the automated support system, such as interactions among the various components of the device components 400, communication with external devices via the communication component 404, and storage and retrieval of code and data to and from the memory component 408. Each application includes executable code to provide specific functionality for the processor 406 and/or remaining components of the automated support system. Examples of applications executable by the processor 406 include, but are not limited to, a communication module 416 to manage communications with other devices of the environment 100, a basic issue module 418 to provide manual tasks to the mobile device 108 to address maintenance events in response to identifying a basic issue, and an advanced issue module 420 to provide a semi-automated tasks to the mobile device to address maintenance events in response to identifying an advanced issue.

Data is information stored at the memory component 408 that may be referenced and/or manipulated by an operating system or application for performing functions of the automated support system and associated components. Examples of data associated with the automated support system and the associated components, stored by the memory component 408, may include, but are not limited to, assistance application data 422 providing data for automated building management assistance such as current and historical records, manual task data 424 providing manual tasks to the mobile device 108 to address maintenance events, and semi-automated task data 426 providing semi-automated tasks to the mobile device to address maintenance events.

The device components 400 of the automated support system may include one or more input components and/or one or more output components, identified by I/O interfaces 428. The I/O interfaces 428 of the device components 400 may include one or more visual, audio, mechanical, and/or other components. For some embodiments, the input components and the output components of the automated support system may comprise a user interface for interaction with a user of the automated support system.

It is to be understood that FIG. 4 is provided for illustrative purposes only to represent examples of the device components 400 of the automated support system and is not intended to be a complete diagram of the various components that may be utilized by the appliance. Therefore, the device may include various other components not shown in FIG. 4, may include a combination of two or more components, or a division of a particular component into two or more separate components, and still be within the scope of the present invention.

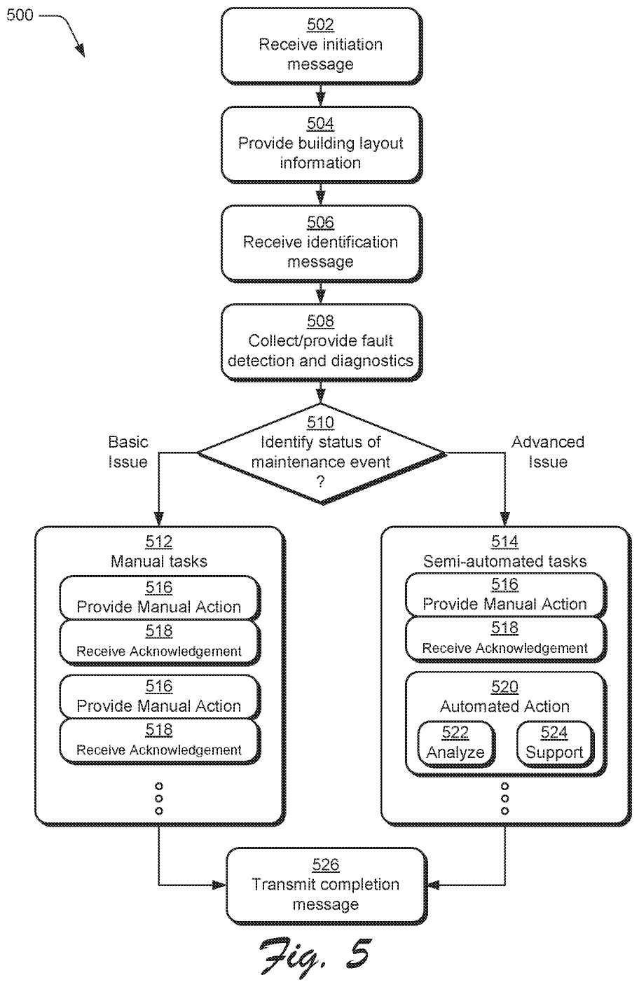

Referring to FIG. 5, there is shown a flow diagram of an example operation 500 of the automated support system 112, 308. The automated support system 112 for automated building management assistance receives, from a mobile device 108, a first message identifying a maintenance event for equipment at a particular building 502. The first message may be an initiation message that includes, or be accompanied by, a message or data identifying a global positioning system location of the mobile device 108 or a confirmation that the mobile device is positioned at a location corresponding to the maintenance event.

For some embodiments, the automated support system 112 may provide to the mobile device 108 building layout information about the particular building 504. Examples of the building layout information includes, but are not limited to, one or more of the following: structure, equipment, venting, plumbing, and wiring layout associated with the particular building.

For some embodiments, the automated support system 112 may receive from the mobile device 108 an identification message 506, which may be, or may include, an authentication code to allow the mobile device to access the automated support system. For example, the authentication code may be indicated by a ticket of the CMMS 118 for operation of the mobile device 108, such as accessing or logging-in to the mobile app 110. For some embodiments, meta data may become available to the mobile device 108 in response to receipt of the authentication code by the automated support system 112.

The automated support system 112 collects from a building automation system, or provides to the mobile device 108, fault detection and diagnostics (FDD) relating to the maintenance event in response to receiving the first message 508. In the alternative, the automated support system 112 may collect the FDD relating to the maintenance event in response to providing the building layout information 504 and/or receiving the identification message 506. Examples of the FDD datum or data includes, but are not limited to, one or more of the following: a current operating state of at least one unit of the building maintenance system, a current communication states between at least two units of the building maintenance system, a previous maintenance event of the equipment, and a recent maintenance event of the building maintenance system.

The automated support system 112 may identify a status of the maintenance event based on the fault detection and diagnostics 510 in response to collecting or providing the FDD relating to the maintenance event. The status may be a basic issue or an advanced issue. The automated support system 112 may provide manual tasks to the mobile device 108 to address the maintenance event 512 in response to identifying the status as the basic issue. The automated support system 112 may provide semi-automated tasks to the mobile device 108 to address the maintenance event 514 in response to identifying the status as the advanced issue. In providing the manual tasks 512, the automated support system 112 may provide manual actions 516 to be executed at the equipment at the particular building based on interactions between the automated support system and the mobile device 108. For some embodiments, the automated support system 112 may receive from the mobile device 108 an acknowledgement 518 in response to providing the manual actions 516. Examples of manual tasks include, but are not limited to, one or more technician tasks such as checking a component of the equipment, cleaning the component of the equipment, or changing the component of the equipment.

In providing the semi-automated tasks 514, the automated support system 112 may provide one or more manual actions 516 and one or more automated actions 520 determined by the automated support system 112 for execution by the building automation system. An example of an automated action is, but is not limited to, requesting the BAS 104 to operate one or more field devices and collecting information from one or more sensors of the BAS. Another example of an automated action is, but is not limited to, automatically connecting the mobile device 108 to a remote technical support center 114 or automatically queuing the mobile device for communication with the remote technical support center in response to identifying a particular task requiring non-automated assistance 524.

The automated support system 112 may transmit, to the mobile device 108, a second message identifying completion of the maintenance event for the equipment at the particular building.

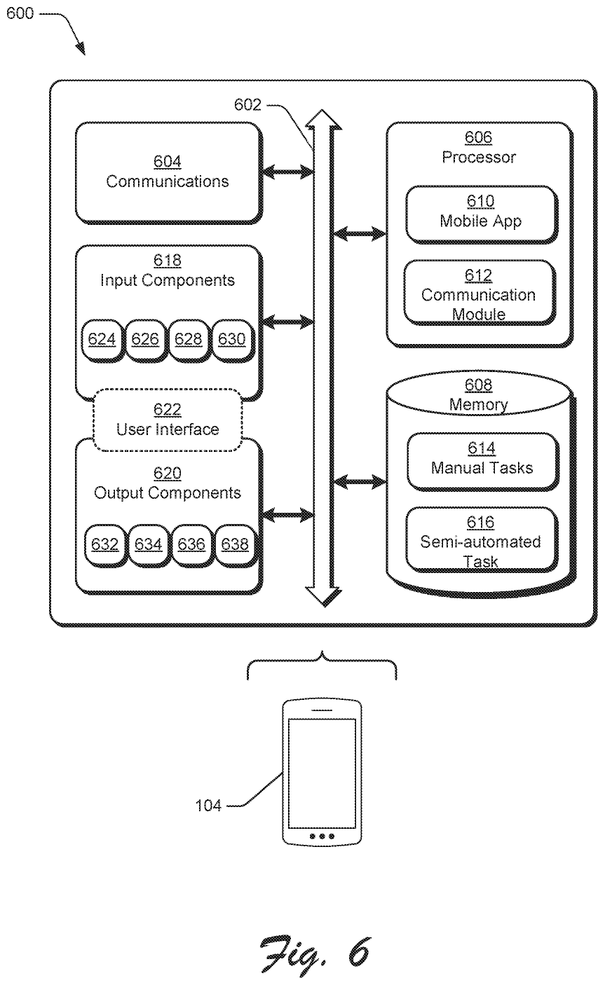

FIG. 6 represents example device components 600 of a mobile device that may operate in the environment 100, employing the techniques described herein, such as the mobile device 108 of FIG. 1. The device components 600 comprise a communication bus 602 for interconnecting components directly or indirectly. The device components further comprise one or more communication components 604 communicating other entities of the environment 100 via a wireless link, one or more processors 606, and one or more memory components 608. The communication component 604 of the device components 600 utilize wireless technology for communication, such as, but are not limited to, Bluetooth (including BLE), Wi-Fi (including Wi-Fi Direct), Zigbee, Z-Wave, 6LoWPAN, Near-Field Communication, other types of electromagnetic radiation of a radio frequency wave, light-based communications (including infrared), acoustic communications, and any other type of peer-to-peer technology.

The processor 606 may execute code and process data received other components of the device components 600. The code associated with the mobile device and stored by the memory component 608 may include, but is not limited to, operating systems, applications, modules, drivers, and the like. An operating system includes executable code that controls basic functions of the mobile device, and each application includes executable code to provide specific functionality for the processor 606 and/or remaining components of the mobile device. Examples of applications executable by the processor 606 include, but are not limited to, a mobile app 610 (which is an example implementation of the mobile app 110 of FIG. 1) automated building management assistance and a communication module 612 to manage communications with other devices of the environment 100.

Data is information stored at the memory component 608 that may be referenced and/or manipulated by an operating system or application for performing functions of the mobile device and associated components. Examples of data associated with the mobile device and the associated components, stored by the memory component 608, may include, but are not limited to, manual task data 614 providing manual tasks to the mobile device 108 to address maintenance events, and semi-automated task data 616 providing semi-automated tasks to the mobile device to address maintenance events.

The device components 600 of the mobile device may include one or more input components 618 and/or one or more output components 620. The input components 618 and/or the output components 620 of the device components 600 may include one or more visual, audio, mechanical, and/or other components. For some embodiments, the input components 618 and the output components 620 of the mobile device may comprise a user interface 622 for interaction with a user of the mobile device. Examples of input components 618 includes, but are not limited to, a microphone 624, an imager 626, a touch input surface 628 (such as a touch pad or touch screen), a motion sensor 630, one or more selection buttons, and an environmental sensor. Examples of output components 620 include, but are not limited to, a speaker 632, a projector 634, a display 636 (such as a touch screen), and a haptic generator 638, and an environmental condition generator.

It is to be understood that FIG. 6 is provided for illustrative purposes only to represent examples of the device components 600 of the mobile device and is not intended to be a complete diagram of the various components that may be utilized by the appliance. Therefore, the device may include various other components not shown in FIG. 6, may include a combination of two or more components, or a division of a particular component into two or more separate components, and still be within the scope of the present invention.

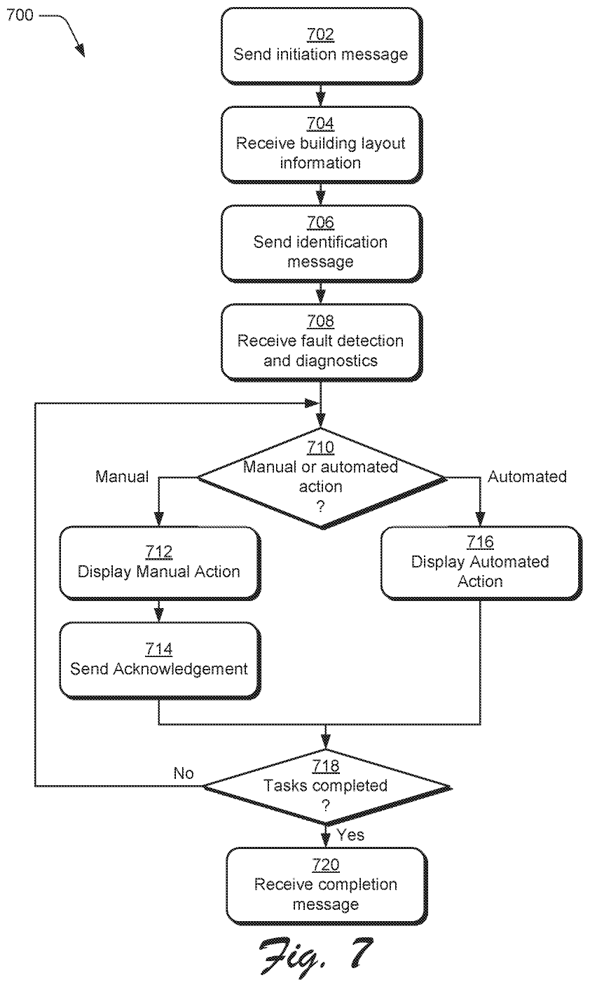

Referring to FIG. 7, there is shown a flow diagram of an example operation 700 of the mobile device 108. The mobile device 108 for automated building management assistance sends, to an automated support system 112, a first message identifying a maintenance event for equipment at a particular building 702. The first message may be an initiation message that includes, or be accompanied by, a message or data identifying a global positioning system location of the mobile device 108 or a confirmation that the mobile device is positioned at a location corresponding to the maintenance event.

For some embodiments, the mobile device 108 may receive from the automated support system 112 building layout information about the particular building 704. Examples of the building layout information includes, but are not limited to, one or more of the following: structure, equipment, venting, plumbing, and wiring layout associated with the particular building.

For some embodiments, the mobile device 108 may send to the automated support system 112 an identification message 706, which may be, or may include, an authentication code to allow the mobile device to access the automated support system. For example, the authentication code may be indicated by a ticket of the CMMS 118 for operation of the automated support system 112, such as accessing or logging-in to the mobile app 110. For some embodiments, meta data may become available to the mobile device 108 in response to receipt of the authentication code by the automated support system 112.

The mobile device 108 receives from the automated support system 112 fault detection and diagnostics (FDD), generated by the BAS 104, relating to the maintenance event 708 in response to receiving the first message. In the alternative, the mobile device 108 may receive the FDD relating to the maintenance event in response to receiving the building layout information 704 and/or sending the identification message 706. Examples of the FDD datum or data includes, but are not limited to, one or more of the following: a current operating state of at least one unit of the building maintenance system, a current communication states between at least two units of the building maintenance system, a previous maintenance event of the equipment, and a recent maintenance event of the building maintenance system.

The mobile device 108 may receive from the automated support system 112 a manual action or an automated action 710 in response to receiving the FDD relating to the maintenance event. The mobile device 108, or in conjunction with a user of the mobile device, may receive manual actions 712 to be executed at the equipment at the particular building based on interactions between the mobile device and the automated support system 112. For example, the mobile device 108 may include an output component for displaying a manual action. For some embodiments, the mobile device 108 may send to the automated support system 112 an acknowledgement 714 in response to receiving the manual actions 516 and performing the specified manual action. Examples of manual actions include, but are not limited to, one or more technician tasks such as checking a component of the equipment, cleaning the component of the equipment, or changing the component of the equipment.

The mobile device 108, or in conjunction with a user of the mobile device, may receive automated actions 716 to be executed at the equipment at the particular building based on interactions between the mobile device and the automated support system 112. For example, the mobile device 108 may include an output component for displaying an automated action so that the mobile device, or a user of the mobile device, may receive notification of the specified automated action, as activated by the BAS 104. An example of an automated action by the automated support system 112 is, but is not limited to, requesting the BAS 104 to operate one or more field devices and collecting information from one or more sensors of the BAS. Another example of an automated action is, but is not limited to, automatically connecting the mobile device 108 to a remote technical support center 114 or automatically queuing the mobile device for communication with the remote technical support center in response to identifying a particular task requiring non-automated assistance.

As each manual action or automated action is completed, the mobile device 108 may determine, in conjunction with the automated support system 112, whether then associated manual or semi-automated task has been completed 718. If the associated manual or semi-automated task has not be completed 718, then the operation 700 may continue may to receive from the automated support system 112 a manual action or an automated action 710. Otherwise, if the associated manual or semi-automated task has been completed 718, then the mobile device 108 may receive from the automated support system 112 a second message identifying completion of the maintenance event for the equipment at the particular building 720.

Those skilled in the art will recognize that, for simplicity and clarity, the full structure and operation of all data processing systems suitable for use with the present disclosure are not being depicted or described herein. Also, none of the various features or processes described herein should be considered essential to any or all embodiments, except as described herein. Various features may be omitted or duplicated in various embodiments. Various processes described may be omitted, repeated, performed sequentially, concurrently, or in a different order. Various features and processes described herein can be combined in still other embodiments as may be described in the claims.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an example embodiment of the present disclosure has been described in detail, those skilled in the art will understand that various changes, substitutions, variations, and improvements disclosed herein may be made without departing from the spirit and scope of the disclosure in its broadest form.

What is claimed is:

1. A system for automated building management assistance comprising:
a mobile device configured to provide a first message identifying a maintenance event for equipment at a particular building and receive a second message identifying completion of the maintenance event for the equipment at the particular building;
a building automation system configured to provide fault detection and diagnostics relating to the maintenance event in response to receiving the first message; and
a support system configured to identify a status of the maintenance event as a basic issue or an advanced issue based on the fault detection and diagnostics, provide a plurality of manual tasks to the mobile device to address the maintenance event in response to identifying the status as the basic issue, and provide a plurality of semi-automated tasks to the mobile device to address the maintenance event in response to identifying the status as the advanced issue,
wherein the plurality of manual tasks include a plurality of manual actions to be executed at the equipment at the particular building based on interactions between the automated support system and the mobile device, and
wherein the plurality of semi-automated tasks include at least one manual action of the plurality of manual tasks and at least one automated action determined by the automated support system for execution by the building automation system.

2. The system as described in claim 1, wherein the mobile device provides a third message identifying a global positioning system location of the mobile device or a confirmation that the mobile device is positioned at a location corresponding to the maintenance event.

3. The system as described by claim 1, wherein the automated support system provides building layout information about the particular building to the mobile device in response to receiving the message identifying the maintenance event, the building layout information including at least one of structure, equipment, venting, plumbing, or wiring layout associated with the particular building.

4. The system as described by claim 1, further comprising a computerized maintenance management system configured to provide scheduling information associated with the maintenance event to the support system and/or mobile device.

5. The system as described by claim 1, wherein the fault detection and diagnostics provided by the building automation system includes at least one datum of the fault detection and diagnostics selected from a group consisting of a current operating state of at least one unit of the building maintenance system, a current communication states between at least two units of the building maintenance system, a previous maintenance event of the equipment, or a recent maintenance event of the building maintenance system.

6. The system as described by claim 1, further comprising a technical support system comprising an activity tracking system and a plurality of technical support terminals communicating with the activity tracking system,
wherein the technical support system connects with the mobile device, or adds the mobile device to its queue, in response to the automated support system identifying a particular task requiring non-automated assistance.

7. A support system for automated building management assistance comprising:
a first communication component configured to communicate with a mobile device, the first communication component receiving a first message identifying a maintenance event for equipment at a particular building and transmitting a second message identifying completion of the maintenance event for the equipment at the particular building;
a second communication component configured to communicate with a building automation system, the second communication component collecting fault detection and diagnostics relating to the maintenance event in response to receiving the first message; and
a processor configured to identify a status of the maintenance event as a basic issue or an advanced issue based on the fault detection and diagnostics, provide a plurality of manual tasks to the mobile device to address the maintenance event in response to identifying the status as the basic issue, and provide a plurality of semi-automated tasks to the mobile device to address the maintenance event in response to identifying the status as the advanced issue,
wherein the plurality of manual tasks include a plurality of manual actions to be executed at the equipment at the particular building based on interactions between the automated support system and the mobile device, and
wherein the plurality of semi-automated tasks include at least one manual action of the plurality of manual tasks and at least one automated action determined by the automated support system for execution by the building automation system.

8. The support system as described in claim 7, wherein the first communication component receives a third message identifying a global positioning system location of the mobile device or a confirmation that the mobile device is positioned at a location corresponding to the maintenance event.

9. The support system as described in claim 7, wherein the first communication component provides building layout information about the particular building to the mobile device in response to receiving the message identifying the maintenance event, the building layout information including at least one of structure, equipment, venting, plumbing, or wiring layout associated with the particular building.

10. The support system as described in claim 7, wherein the second communication component receives at least one datum of the fault detection and diagnostics selected from a group consisting of a current operating state of at least one unit of the building maintenance system, a current communication states between at least two units of the building maintenance system, a previous maintenance event of the equipment, or a recent maintenance event of the building maintenance system.

11. The support system as described in claim 7, wherein the plurality of manual tasks include at least one technician task selected from a group consisting of checking a component of the equipment, cleaning the component of the equipment, or changing the component of the equipment.

12. The support system as described in claim 7, wherein the at least one diagnostic task determined by the support system for execution by the building automation system includes requesting the building automation system to operate at least one field device and collecting information from at least one sensor of the building automation system.

13. The support system as described in claim 7, further comprising a third communication component automatically connecting the mobile device to a remote Support Center or automatically queuing the mobile device for communication with the remote Support Center in response to the processor identifying a particular task requiring non-automated assistance.

14. A method of a support system for automated building management assistance, the method comprising:
receiving, from a mobile device, a first message identifying a maintenance event for equipment at a particular building;
collecting, from a building automation system, fault detection and diagnostics relating to the maintenance event in response to receiving the first message;
identifying a status of the maintenance event based on the fault detection and diagnostics, the status being one of a basic issue or an advanced issue;
providing a plurality of manual tasks to the mobile device to address the maintenance event in response to identifying the status as the basic issue, wherein the plurality of manual tasks include a plurality of manual actions to be executed at the equipment at the particular building based on interactions between the automated support system and the mobile device;
providing a plurality of semi-automated tasks to the mobile device to address the maintenance event in response to identifying the status as the advanced issue, wherein the plurality of semi-automated tasks include at least one manual action of the plurality of manual tasks and at least one automated action determined by the automated support system for execution by the building automation system; and
transmitting, to the mobile device, a second message identifying completion of the maintenance event for the equipment at the particular building.

15. The method as described in claim 14, further comprising receiving, from the mobile device, a third message identifying a global positioning system location of the mobile device or a confirmation that the mobile device is positioned at a location corresponding to the maintenance event.

16. The method as described in claim 14, further comprising providing building layout information about the particular building to the mobile device in response to receiving the first message identifying the maintenance event, the building layout information including at least one of structure, equipment, venting, plumbing, or wiring layout associated with the particular building.

17. The method as described in claim 14, wherein collecting the fault detection and diagnostics relating to the maintenance event includes receiving at least one datum selected from a group consisting of a current operating state of at least one unit of the building maintenance system, a current communication states between at least two units of the building maintenance system, a previous maintenance event of the equipment, or a recent maintenance event of the building maintenance system.

18. The method as described in claim 14, wherein the plurality of manual tasks include at least one technician task selected from a group consisting of checking a component of the equipment, cleaning the component of the equipment, or changing the component of the equipment.

19. The method as described in claim 14, wherein the at least one automated task determined by the automated support system for execution by the building automation system includes requesting the building automation system to operate at least one field device and collecting information from at least one sensor of the building automation system.

20. The method as described in claim 14, further comprising automatically connecting the mobile device to a remote Support Center or automatically queuing the mobile device for communication with the remote Support Center in response to identifying a particular task requiring non-automated assistance.
